(19) United States
(12) Patent Application Publication
(10) Pub. No.: US 2021/0041657 A1
(43) Pub. Date: Feb. 11, 2021

(54) LENS MODULE

(71) Applicant: AAC Optics Solutions Pte. Ltd., Singapore City (SG)

(72) Inventor: Yuchan Gao, Shenzhen (CN)

(21) Appl. No.: 16/987,420

(22) Filed: Aug. 7, 2020

(30) Foreign Application Priority Data
Aug. 9, 2019 (CN) 201921293620.3

(51) Int. Cl. G02B 7/02; G02B 13/18

(52) U.S. Cl. CPC G02B 7/026; G02B 7/025; G02B 13/18; G02B 7/021

(57) ABSTRACT

Provided is a lens module, including: a lens barrel; a lens group; and a pressing ring fixedly holding the lens group in the lens barrel. The lens barrel includes a first surface recessed towards the first barrel wall to form a first adhesive receiving groove. The pressing ring includes a fixing portion. A side of the fixing portion close to the second barrel wall is recessed along a direction facing away from the second barrel wall to form a second adhesive receiving groove. By providing the first and second adhesive receiving grooves at a position where the pressing ring is bonded to the lens barrel, a bonding area of the adhesive is increased, so that the pressing ring can be bonded to the lens barrel more firmly, and the lens group is more stable in the lens barrel. This structure can effectively improve stability and reliability of the lens module.

### TECHNICAL FIELD

The present invention relates to the field of optical imaging, and more particularly, to a lens module applied in the field of camera products.

### BACKGROUND

With advancement of science and technology, camera lenses have been more widely applied. At present, in addition to cameras, electronic products such as mobile phones and computers have been equipped with camera lenses so that people can take pictures anytime and anywhere, thereby bringing convenience and fun to people's lives.

In the related art, a lens module includes a lens barrel, a lens received in the lens barrel, and a pressing ring that fixedly holds the lens in the lens barrel. The pressing ring is fixed to the lens barrel by an adhesive, and the lens is then fixed to the lens barrel by an adhesive, thereby achieving fixing of the lens.

However, in the related art, the lens of the lens module is fixed to the lens barrel by adhesive dispensing after the pressing ring abuts against the lens, and then the lens is fixed in the lens barrel. In this case, since a bonding surface of the lens barrel and the pressing ring is relatively flat, such bonding manner may cause a risk of adhesive cracking or even falling off of a lens group during a reliability drop test. As a result, the lens may be displaced, bringing a great threat for a camera function of the mobile phone.

Therefore, it is needed to provide a new lens module to solve the above-mentioned problems.

### SUMMARY

The present invention aims to provide a lens module with high stability and good optical performance.

In order to solve the technical problem described above, the present invention provides a lens module, including: a lens barrel; a lens group arranged in the lens barrel and having an optical axis; and a pressing ring fixedly holding the lens group in the lens barrel. The lens barrel includes a first barrel wall provided with a light-through hole, and a second barrel wall extending from the first barrel wall while being bent; the first barrel wall and the second barrel wall define a receiving space for receiving the lens group; the second barrel wall includes an inner surface and an outer surface that extend from the first barrel wall and are arranged around the optical axis, and a first surface connecting the inner surface with the outer surface; the inner surface is opposite to the outer surface and is closer to the lens group than the outer surface; the pressing ring includes a fixing portion fixed to the first surface and an extension portion extending from the fixing portion towards the optical axis; the extension portion abuts against a side of the lens group facing away from the light-through hole; the first surface is recessed towards the first barrel wall to form a first adhesive receiving groove, and a side of the fixing portion close to the second barrel wall is recessed along a direction facing away from the second barrel wall to form a second adhesive receiving groove; the fixing portion is opposite to the first surface, and the fixing portion is spaced from the first surface with a gap; both the first adhesive receiving groove and the second adhesive receiving groove are in communication with the gap; and the first adhesive receiving groove, the second adhesive receiving groove and the gap are filled with an adhesive, and the adhesive is used for fixing the pressing ring to the lens barrel.

As an improvement, the lens group includes a first lens close to an image side, the first lens includes an optical portion for imaging and a peripheral portion surrounding the optical portion, the peripheral portion includes a bottom surface close to the image side, and the extension portion abuts against the bottom surface to fixedly hold the lens group in the lens barrel.

As an improvement, a plurality of the first adhesive receiving grooves and/or a plurality of the second adhesive receiving grooves are provided, and each of the plurality of the first adhesive receiving grooves and each of the plurality of the second adhesive receiving grooves are alternatively arranged.

As an improvement, the first adhesive receiving groove and/or the second adhesive receiving groove are arranged about the optical axis.

As an improvement, the lens group further includes at least one second lens stacked at an object side of the first lens, and a light-shielding plate arranged sandwiched between the first lens and one of the at least one second lens.

Compared with the related art, the lens module of the present invention provides the first adhesive receiving groove and the second adhesive receiving groove at a position where the pressing ring is bonded to the lens barrel, so that a bonding area of the adhesive is increased. Therefore, the pressing ring can be bonded to the lens barrel more firmly. Thus, the lens group is more stable in the lens barrel. This structure can effectively improve stability and reliability of the lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic diagram of a structure of a lens module according to the present invention;

FIG. 2 is an enlarged view of part A shown in FIG. 1.

FIG. 3 is a schematic diagram of a structure of the lens module shown in FIG. 1 that is not filled with an adhesive;

FIG. 4 is an exploded view of a part of the structure of the lens module shown in FIG. 3; and

FIG. 5 is an enlarged view of part B shown in FIG. 3.

### DESCRIPTION OF EMBODIMENTS

The present invention will be further described in the following with reference to the accompanying drawings and embodiments.

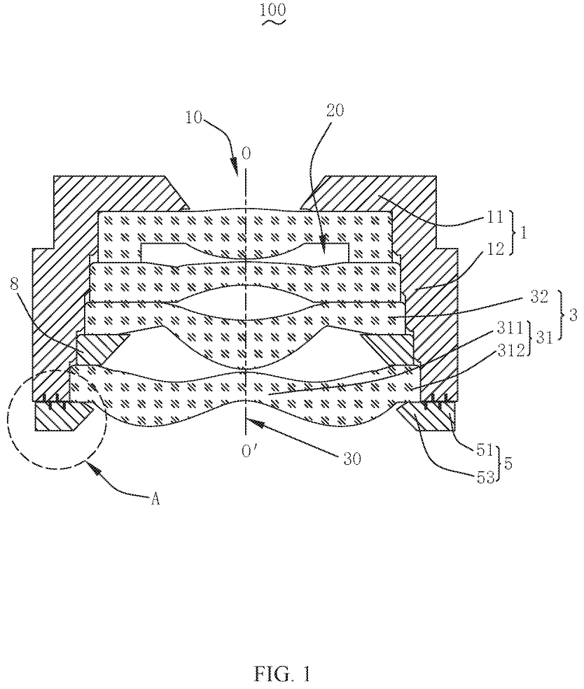

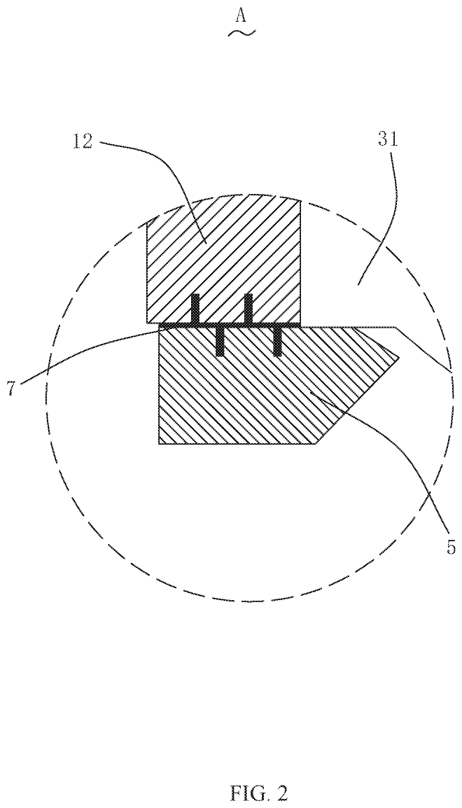

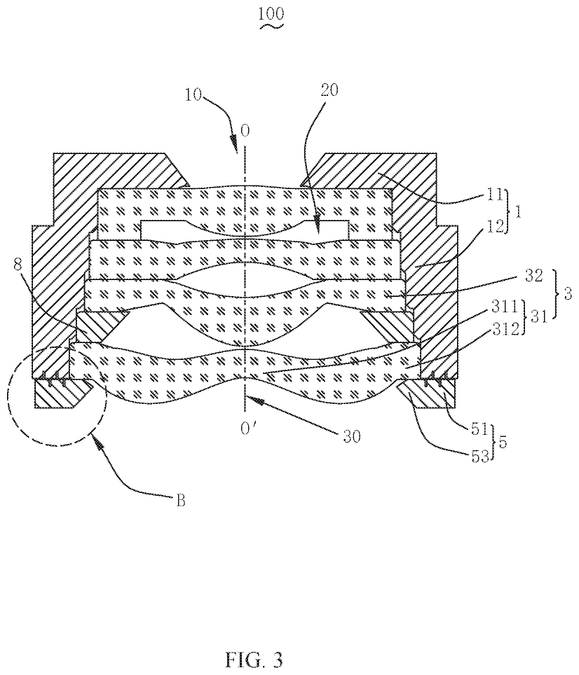

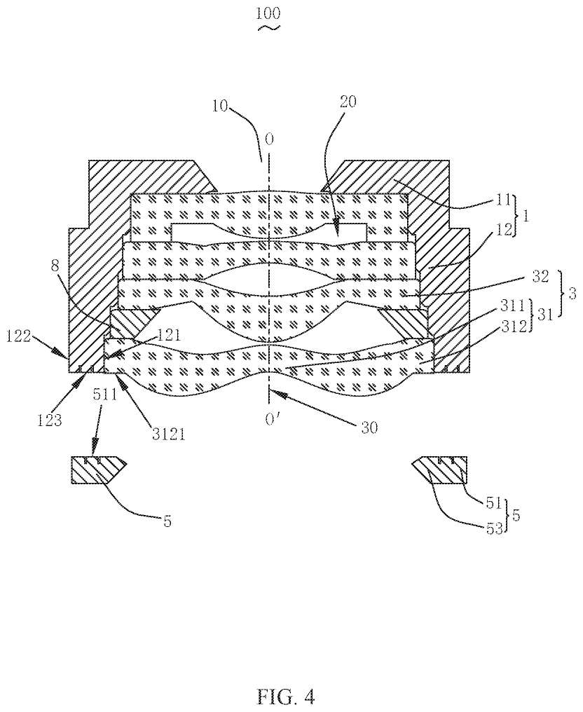

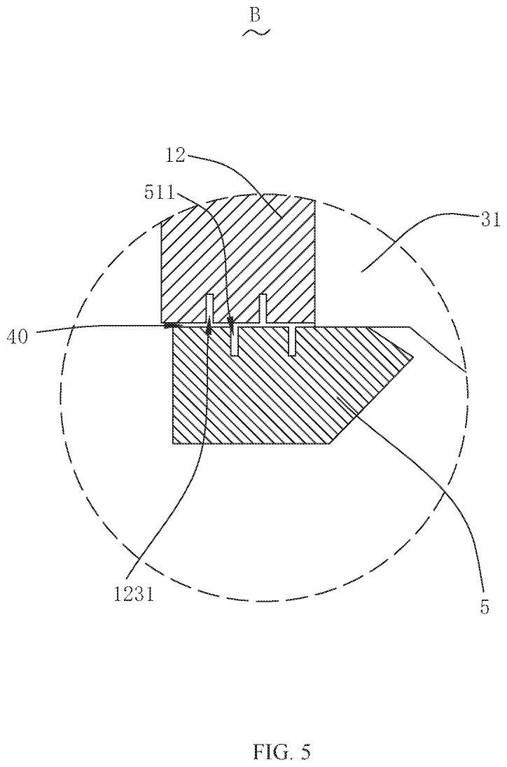

FIG. 1 is a schematic diagram of a structure of a lens module according to the present invention. FIG. 2 is an enlarged view of part A shown in FIG. 1. FIG. 3 is a schematic diagram of a structure of the lens module shown in FIG. 1 that is not filled with an adhesive. FIG. 4 is an exploded view of a part of the structure of the lens module shown in FIG. 3. FIG. 5 is an enlarged view of a portion B shown in FIG. 3. With reference to FIG. 1 to FIG. 5, a lens module 100 includes a lens barrel 1, a lens group 3 arranged in the lens barrel 1, and a pressing ring 5 for fixedly holding the lens group 3 in the lens barrel 1. The lens group 3 has an optical axis 30.

The lens barrel 1 includes a first barrel wall 11 provided with a light-through hole 10, and a second barrel wall 12 extending from the first barrel wall 11 while being bent. The first barrel wall 11 and the second barrel wall 12 define a receiving space 20 that receives the lens group 3. The second barrel wall 12 includes an inner surface 121 and an outer surface 122 that extend from the first barrel wall 11 and are arranged around the optical axis 30, and a first surface 123 connecting the inner surface 121 with the outer surface 122. The inner surface 121 is opposite to the outer surface 122 and is closer to the lens group 3 than the outer surface 122.

The pressing ring 5 includes a fixing portion 51 fixed to the first surface 123 and an extension portion 53 extending from the fixing portion 51 towards the optical axis 30. The extension portion 53 abuts against a side of the lens group 3 facing away from the light-through hole 10.

The first surface 123 is recessed towards the first barrel wall 11 to form a first adhesive receiving groove 1231, and a side of the fixing portion 51 close to the second barrel wall 12 is recessed along a direction facing away from the second barrel wall 12 to form a second adhesive receiving groove 511. The fixing portion 51 is opposite to the first surface 123, and is spaced from the first surface 123 with a gap 40. Both the first adhesive receiving groove 1231 and the second adhesive receiving groove 511 are in communication with the gap 40. An adhesive 70 is filled in the first adhesive receiving groove 1231, the second adhesive receiving groove 511 and the gap 40. The adhesive 7 fixes the pressing ring 5 to the lens barrel 1.

After filling, the adhesive 7 is cured in the first adhesive receiving groove 1231, the second adhesive receiving groove 511 and the gap 40. In this way, a contact area of the pressing ring 5 and the adhesive 7 and a contact area of the lens barrel 1 and the adhesive 7 can be increased, thereby increasing bonding reliability.

The lens group 3 includes a first lens 31 close to an image side, and the first lens 31 includes an optical portion 311 for imaging and a peripheral portion 312 surrounding the optical portion 311. The peripheral portion 312 includes a bottom surface 3121 close to the image side. The extension portion 53 abuts against the bottom surface 3121 to fixedly hold the lens group 3 in the lens barrel 1 and can also shield stray light from the lens group 3, thereby improving an optical performance of the module 100. In an example, the lens group 3 further includes at least one second lens 32 stacked at an object side of the first lens 31, and a light-shading plate 8 sandwiched between the second lens 32 and the first lens 31. The light-shielding plate 8 further shields the stray light.

A plurality of first adhesive receiving grooves 1231 and a plurality of second adhesive receiving grooves 511 may be provided. The first adhesive receiving grooves 1231 and the second adhesive receiving grooves 511 are alternately arranged. In this embodiment, two first adhesive receiving grooves 1231 and two second adhesive receiving grooves 511 are provided, and the two first adhesive receiving grooves 1231 and the two second adhesive receiving grooves 511 are alternately arranged. In this case, the cured adhesive 7 is also formed into a staggered structure, thereby further improving the bonding reliability.

In an example, the first adhesive receiving groove 1231 and/or the second adhesive receiving groove 511 may be an annular groove arranged in the inner surface 121 and the outer surface 511, and the first adhesive receiving groove 1231 and/or the second adhesive receiving groove 511 are arranged about the optical axis 30. The adhesive 7 is formed into a fixed ring (not shown in the figure) after being cured. An increase of an adhesive area of the adhesive 7 can allow the pressing ring 5 be better fixed to the lens barrel 1. In other embodiments, the first adhesive receiving groove 1231 and/or the second adhesive receiving groove 511 may also be formed into a thread structure, so that the filled adhesive 7 is formed as a reverse thread, thereby further improving the bonding reliability. In other words, the first adhesive receiving groove 1231 and/or the second adhesive receiving groove 511 may be a continuous or discontinuous structure. In this embodiment, due to a small dimension of the adhesive area, an annular groove may be adopted, thereby resulting in a larger contact area with the adhesive 7.

Compared with the related art, the lens module of the present invention provides the first adhesive receiving groove and the second adhesive receiving groove at a position where the pressing ring is bonded to the lens barrel, so that a bonding area of the adhesive is increased. Therefore, the pressing ring can be bonded to the lens barrel more firmly. In this way, the lens group is more stable in the lens barrel. This structure can effectively improve stability and reliability of the lens module.

The above description merely illustrates some embodiments of the present invention, and is not intended to limit a scope of the present invention. Any equivalent structure or equivalent process transformation that is made based on the description and the accompanying drawings of the present invention or that is directly or indirectly applied in other related technical field shall fall into a scope of the present invention.

What is claimed is:

1. A lens module, comprising:
a lens barrel;
a lens group arranged in the lens barrel and having an optical axis; and
a pressing ring fixedly holding the lens group in the lens barrel,
wherein the lens barrel comprises a first barrel wall provided with a light-through hole, and a second barrel wall extending from the first barrel wall while being bent; the first barrel wall and the second barrel wall define a receiving space for receiving the lens group; the second barrel wall comprises an inner surface and an outer surface that extend from the first barrel wall and are arranged around the optical axis, and a first surface connecting the inner surface with the outer surface; the inner surface is opposite to the outer surface and is closer to the lens group than the outer surface; the pressing ring comprises a fixing portion fixed to the first surface and an extension portion extending from the fixing portion towards the optical axis; the extension portion abuts against a side of the lens group facing away from the light-through hole; the first surface is recessed towards the first barrel wall to form a first adhesive receiving groove, and a side of the fixing portion close to the second barrel wall is recessed along a direction facing away from the second barrel wall to form a second adhesive receiving groove; the fixing portion is opposite to the first surface, and the fixing portion is spaced from the first surface with a gap; both the first adhesive receiving groove and the second adhesive receiving groove are in communication with the gap; and the first adhesive receiving groove, the second adhesive receiving groove and the gap are filled with an adhesive, and the adhesive is used for fixing the pressing ring to the lens barrel.

2. The lens module as described in claim 1, wherein the lens group comprises a first lens close to an image side, the first lens comprises an optical portion for imaging and a peripheral portion surrounding the optical portion, the peripheral portion comprises a bottom surface close to the image side, and the extension portion abuts against the bottom surface to fixedly hold the lens group in the lens barrel.

3. The lens module as described in claim 1, wherein a plurality of the first adhesive receiving grooves and/or a plurality of the second adhesive receiving grooves are provided, and each of the plurality of the first adhesive receiving grooves and each of the plurality of the second adhesive receiving grooves are alternatively arranged.

4. The lens module as described in claim 1, wherein the first adhesive receiving groove and/or the second adhesive receiving groove are arranged about the optical axis.

5. The lens module as described in claim 2, wherein the lens group further comprises at least one second lens stacked at an object side of the first lens, and a light-shielding plate arranged sandwiched between the first lens and one of the at least one second lens.
